(19) United States
(12) Patent Application Publication
(10) Pub. No.: US 2026/0350403 A1
(43) Pub. Date: Nov. 5, 2026

(54) ACCELERATING PROMPT INFERENCING OF LARGE LANGUAGE MODELS

(71) Applicant: QUALCOMM Incorporated, San Diego, CA (US)

(72) Inventors: Wenhao ZHANG, Beijing (CN); Zhiguo LI, Beijing (CN); Xinglong LIANG, Shenzhen (CN)

(21) Appl. No.: 19/490,264

(22) PCT Filed: Nov. 30, 2023
(86) PCT No.: PCT/CN2023/135355

§ 371 Date: Dec. 4, 2025

(51) Int. Cl. G06N 3/091; G06N 3/045

(52) U.S. Cl. CPC G06N 3/091; G06N 3/045

(57) ABSTRACT

A processor-implemented method of accelerating prompt inferencing of large language models includes receiving a first input prompt. The first input prompt includes a first user prompt. A first set of input tokens corresponding to the first input prompt is generated. A first language model determines a first internal state for each of the first set of input tokens. A second language model processes, responsive to the first internal state being determined for all of the first set of input tokens, the first set of input tokens and the first internal state for each of the first set of input tokens, to generate a first set of following tokens for the first input prompt.

### FIELD OF THE DISCLOSURE

Aspects of the present disclosure generally relate to generative artificial intelligence, and more particularly to accelerating prompt inferencing of large language models (LLMs).

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) are a type of feed-forward ANN. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Given the many useful applications of neural networks, there is growing demand for use of neural networks to solve increasingly complex problems in further areas of application. One area of exploration is generative artificial intelligence.

Large language models (LLMs) have made significant advances in the natural language understanding domain and have gained popularity with respect to textual generative tasks as well as tasks that involve modelling information from textual and visual domains. LLMs may receive a prompt from a user, and in turn, may generate a response or completion. However, LLMs may be inefficient in generating the completions, which may result in increasing latency in generating an inference in response to the user prompt and may negatively impact the user experience.

### SUMMARY

In some aspects of the present disclosure, a processor-implemented method includes receiving a first input prompt. The first input prompt includes a first user prompt. The processor-implemented method also includes generating a first set of input tokens corresponding to the first input prompt. The processor-implemented method additionally includes determining, by a first language model, a first internal state for each of the first set of input tokens. The processor-implemented method further includes processing, by a second language model, responsive to determining the first internal state for all of the first set of input tokens, the first set of input tokens and the first internal state for each of the first set of input tokens, to generate a first set of following tokens for the first input prompt.

Various aspects of the present disclosure are directed to an apparatus including means for receiving a first input prompt. The first input prompt includes a first user prompt. The apparatus also includes means for generating a first set of input tokens corresponding to the first input prompt. The apparatus additionally includes means for determining, by a first language model, a first internal state for each of the first set of input tokens. The apparatus further includes means for processing, by a second language model, responsive to determining the first internal state for all of the first set of input tokens, the first set of input tokens and the first internal state for each of the first set of input tokens, to generate a first set of following tokens for the first input prompt.

In some aspects of the present disclosure, a non-transitory computer-readable medium with non-transitory program code recorded thereon is disclosed. The program code is executed by a processor and includes program code to receive a first input prompt. The first input prompt includes a first user prompt. The program code also includes program code to generate a first set of input tokens corresponding to the first input prompt. The program code additionally includes program code to determine, by a first language model, a first internal state for each of the first set of input tokens. The program code further includes program code to process, by a second language model, responsive to determining the first internal state for all of the first set of input tokens, the first set of input tokens and the first internal state for each of the first set of input tokens, to generate a first set of following tokens for the first input prompt.

Various aspects of the present disclosure are directed to an apparatus having at least one memory and one or more processors coupled to the at least one memory. The processor(s) is configured to receive a first input prompt. The first input prompt includes a first user prompt. The processor(s) is also configured to generate a first set of input tokens corresponding to the first input prompt. The processor(s) is additionally configured to determine, by a first language model, a first internal state for each of the first set of input tokens. The processor(s) is further configured to process, by a second language model, responsive to determining the first internal state for all of the first set of input tokens, the first set of input tokens and the first internal state for each of the first set of input tokens, to generate a first set of following tokens for the first input prompt.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary deep convolutional network (DCN) in accordance with various aspects of the present disclosure.

FIG. 4 is a block diagram illustrating an exemplary software architecture that may modularize artificial intelligence (AI) functions, in accordance with various aspects of the present disclosure.

FIGS. 5 and 6 are diagrams illustrating token generation models, in accordance with various aspects of the present disclosure.

FIG. 7 is a diagram illustrating example input prompts, in accordance with various aspects of the present disclosure.

FIG. 8A is a block diagram illustrating example use cases for a key value (KV) model for token generation, in accordance with various aspects of the present disclosure.

FIG. 8B is a block diagram illustrating an architecture of the generative pre-trained transformer (GPT) model of FIG. 8A, in accordance with various aspects of the present disclosure.

FIG. 9A is a block diagram illustrating an example architecture for accelerating prompt inferencing, in accordance with various aspects of the present disclosure.

FIG. 9B is a flow diagram illustrating a process pipeline for accelerating prompt inferencing, in accordance with various aspects of the present disclosure.

FIG. 10 is a flow diagram illustrating a processor-implemented method for accelerating prompt inferencing in large language models, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As described, large language models (LLMs) have made significant advances in the natural language understanding domain, and have gained popularity with respect to textual generative tasks as well as tasks that involve modelling information from textual and visual domains.

One type of LLM is a generative pre-trained transformer (GPT) model. The GPT models may have a decoder-only architecture. GPT models may be trained using a large data set of examples such as publicly available materials including books, news articles, blogs, websites, and video, for instance. Based on the training, GPT models may perform various natural language processing tasks such as question answering, text summarization, and other language processing tasks.

Because of the capabilities and broad application to language tasks, deployment of LLMs on edge devices, such as smartphones, is desirable. However, LLMs may be large and inefficient at generating inferences to user prompts particularly on resource limited devices such as edge devices. Delays in generating inferences to user prompts may significantly impact the user experience.

Accordingly, aspects of the present disclosure are directed to accelerating prompt inferencing of LLMs. In various aspects, a token generation pipeline may be adapted to reduce and, in some aspects, avoid usage of a language modelling head of the LLM for determining an internal state (referred to as KV cache or KV$) for input prompts.

Particular aspects of the subject matter described in this disclosure can be implemented to realize one or more of the following potential advantages. In some examples, the described techniques may reduce latency of prompt inference generation of LLMs to improve user experience.

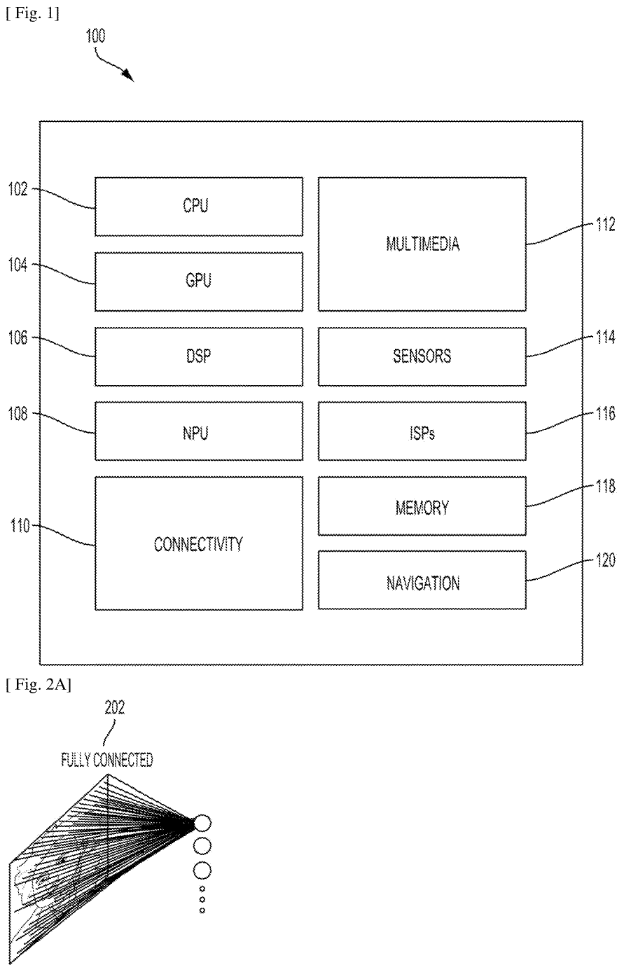

FIG. 1 illustrates an example implementation of a system-on-a-chip (SOC) 100, which may include a central processing unit (CPU) 102 or a multi-core CPU configured for accelerating prompt inferencing in large language models. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive a first input prompt. The first input prompt includes a first user prompt. The instructions loaded into the general-purpose processor 102 may also include code to generate a first set of input tokens corresponding to the first input prompt. The instructions loaded into the general-purpose processor 102 may also include code to determine, by a first language model, a first internal state for each of the first set of input tokens. The instructions loaded into the general-purpose processor 102 may also include code to process, by a second language model, responsive to the first internal state being determined for all of the first set of input tokens, the first set of input tokens and the first internal state for each of the first set of input tokens, to generate a first set of following tokens for the first input prompt.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

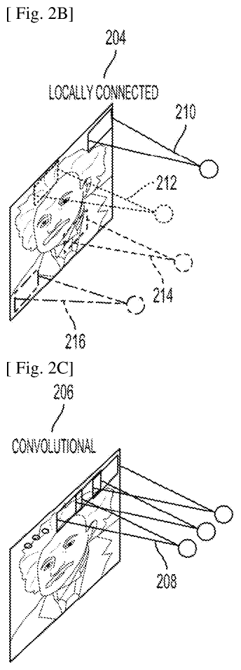

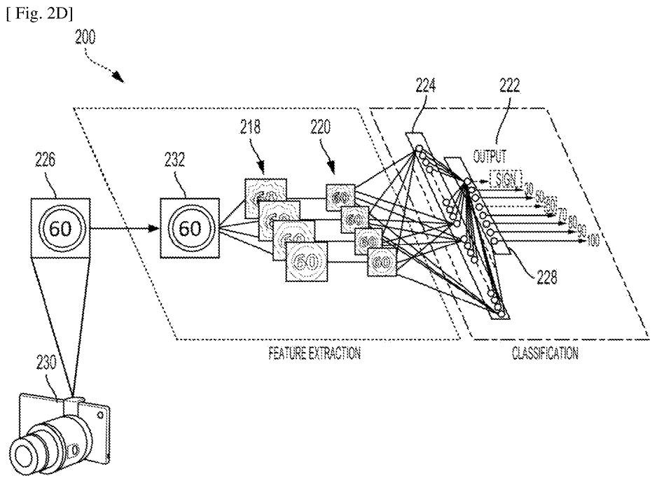

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232.

The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max (0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

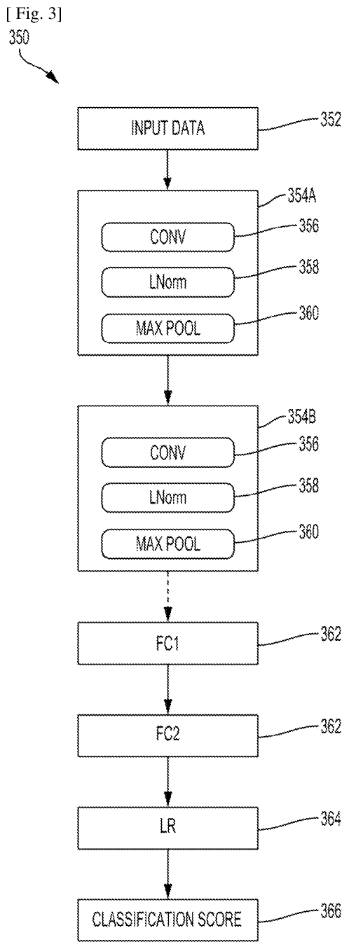

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

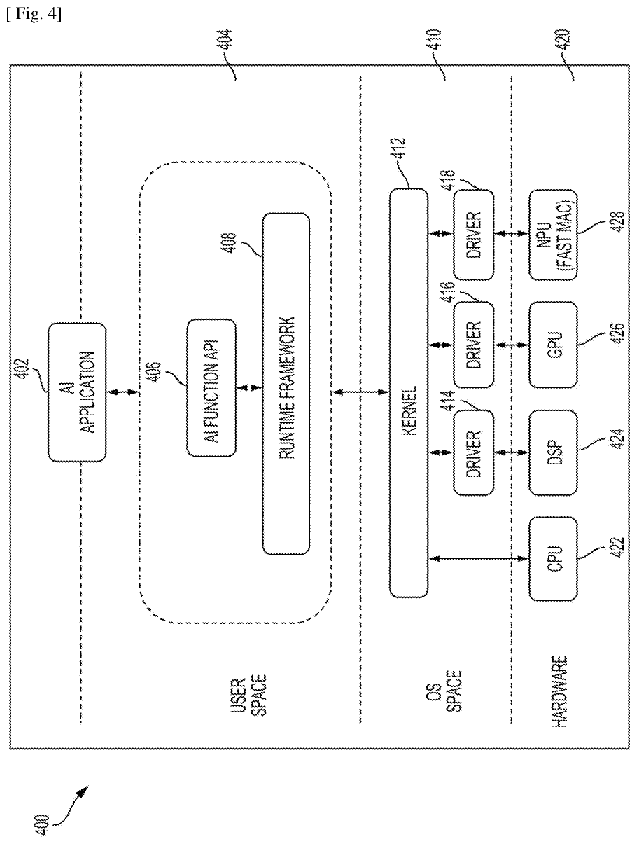

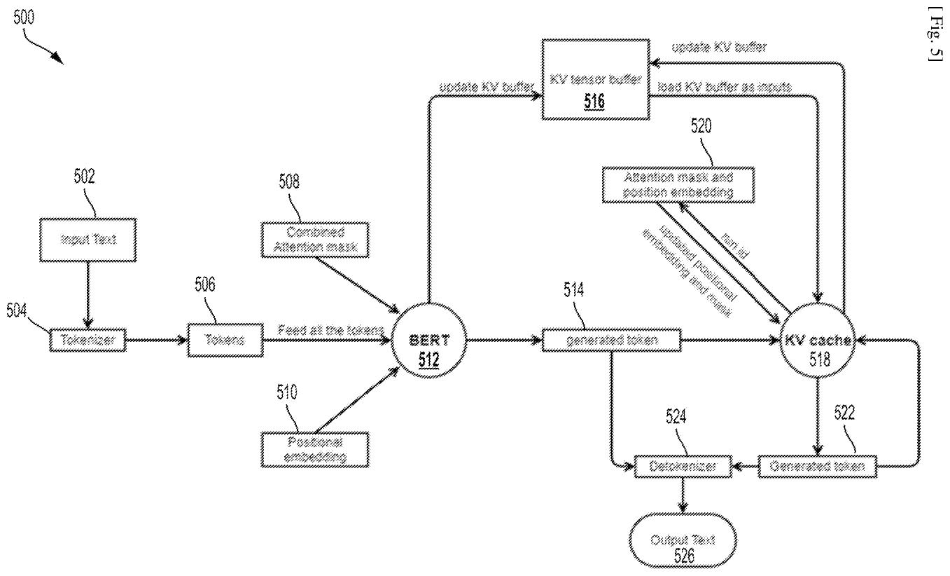

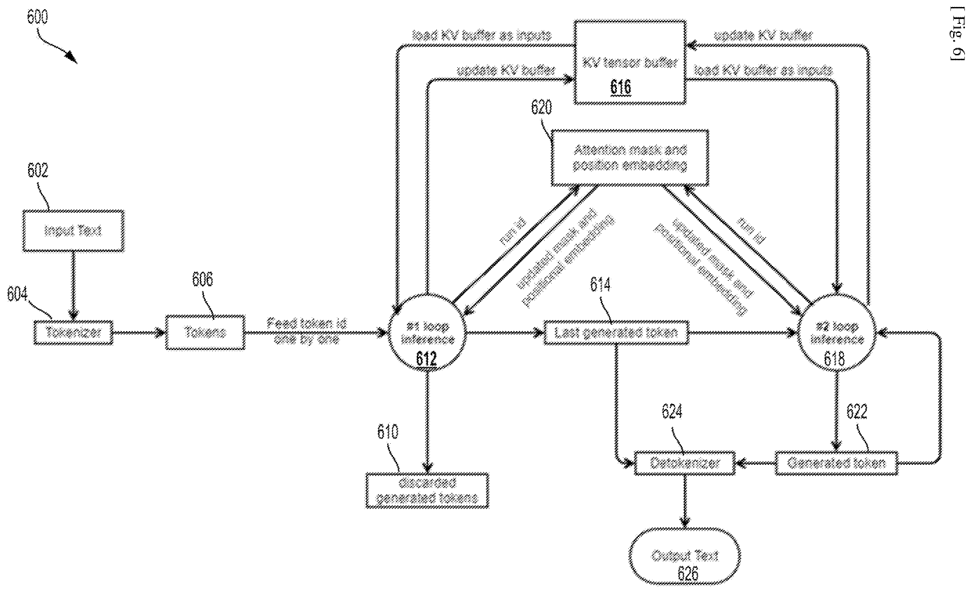

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support accelerating prompt inferencing of large language models (LLMs) for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

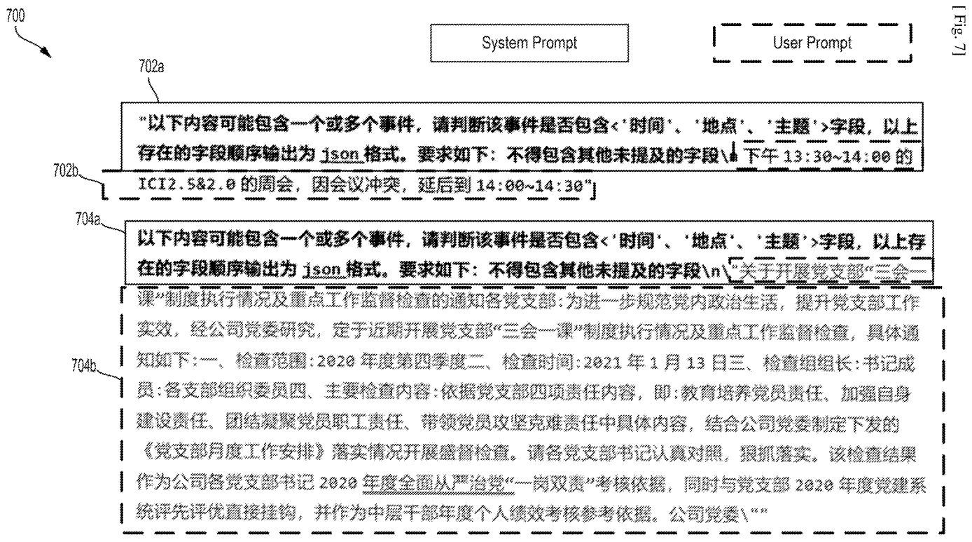

FIGS. 5 and 6 are diagrams illustrating token generation models, in accordance with various aspects of the present disclosure. Referring to FIG. 5, a pipeline including a prefix model, named as BERT, and a generation model, named as KV, 500 is shown. The BERT_KV model 500 provides a pipeline for token generation for a large language model (LLM) 512. Because some neural processors such as the NPU 108 may only support static models with fixed input shape, the BERT_KV model 500 may fix the input shape according to a maximum input length. In doing so, the BERT_KV model 500 may take the data of the user prompt (e.g., valid data) and add padding (e.g., zeros) of the remaining portion of the input such that the input size may be fixed at the maximum length (e.g., 1024 characters).

The BERT_KV model 500 may receive input text 502. The input text 502 may include a system prompt and a user prompt. The system prompt may be a standard prompt that may, for instance, indicate a greeting and/or an instruction to a user for operating the model (e.g., “please enter a question”) . The user prompt may comprise the user input such as a task for the LLM. The user prompt may have a variable length.

The input text 502 may be provided to a tokenizer 504. The tokenizer 504 may divide the input text 502 into multiple portions referred to as tokens 506. A token 506 may comprise a subpart of the input text 502, such as sequence of characters (e.g., a token may be on average about four characters in length), a word, or a phrase. In the BERT_KV model 500, the tokenizer 504 processes the input text 502 that may include, but is not limited to, a word, a sentence, a paragraph, or a document, for example, and may generate all of the tokens 506 for the input text 502. Then, the tokenizer 504 may provide all of the tokens 506 to the LLM 512 at once.

A position embedding 510 may be applied to maintain information related to the order of the tokens 506. An attention mask 508 may also be applied to identify more salient tokens (e.g., 506) corresponding to the input text 502. In turn, the LLM 512 may generate a prediction of a single following token 514. The generated token 514 may be considered a completion, for example, a following word in a response or output. The LLM 512 may be configured to generate multiple tokens 514 in an autoregressive manner by writing the generated token 514 to memory, such as a KV tensor buffer 516 to retain the internal state KV$ (e.g., a data structure referred to as KV cache, which may represent keys (K) and values (V) of the previously generated token) 518. The internal state KV$ 518 may be read from the KV tensor buffer 516 and appended to the previous input tokens 506. Attention mask and position embeddings 520 may be updated and supplied as input to the internal state KV$ 518. As the LLM 512 generates each token 514, the generated token 514 may be processed by a detokenizer 524 in a reciprocal manner to the tokenizer 504 to generate output text 526 (e.g., a sequence of characters, words, or phrases). The process may continue to be repeated in this manner. With each iteration, the generated token 522 may update the internal state KV$ 518 and may be written to the KV tensor buffer 516 to update the KV tensor buffer 516 which may, in turn, be loaded as the following input.

FIG. 6 shows a KV model 600 for token generation. The KV model 600 includes similar components as the BERT_KV model 500, which may perform similar functions as those described with reference to FIG. 5. However, in FIG. 6, the KV model 600 may supply tokens 606 to the LLM 512 one token at a time rather than all tokens at once. In the KV model 600, there is one input, the token 606, and the LLM 512 generates a first inference, shown as a last generated token 614, which may be detokenized to generate one output 626. The KV tensor buffer 516 may be updated based on the last generated token 614 and the generated token may be discarded at block 610. The next token 606 corresponding to the inputs may be received and may be appended to the internal state loaded from the KV tensor buffer 516 to generate a second token 622 at a second inference 618, which may be detokenized by a detokenizer 524, and output as output 626. Then, the KV tensor buffer 516 may be updated based on the last generated token 614 and the generated token may be discarded at block 610. The process may repeat until all of the tokens 606 corresponding the input are looped in and processed by the LLM 512.

In summary, the BERT_KV model 500 takes all of the input prompts (e.g., tokens 506) at one time and generates the first token and the KV cache of the input prompt. On the other hand, the KV model 600 takes all of the input prompts one token at a time and generates the first token and KV cache of the prompt. As such, the first token latency for the KV model 600 may be less than the first token latency for the BERT_KV model 500. Because the BERT_KV model 500 takes all inputs prompts (e.g., system prompt and user prompt) at one time, the input dimensions may be fixed at a maximum length (e.g., 1024 characters). Thus, the first token latency for the BERT_KV model 500 may also be fixed at the time for processing the maximum input length (e.g., 2.2 seconds), regardless of the length of the input prompts. On the other hand, because the KV model 600 takes the input prompts and processes the input prompts, one token at a time, the first token latency may depend on the length of the input prompts (e.g., 100 milliseconds per token).

FIG. 7 is a diagram illustrating example input prompts 700, in accordance with various aspects of the present disclosure. Referring to FIG. 7, the example input prompts 700 may be received by a computing system including, for instance, the SOC 100 or a component thereof. The example input prompts 700 may include a system prompt (e.g., 702a, 704a) and a user prompt (e.g., 702b, 704b). The input prompts 700 may include a sequence of letters, numbers, or other characters. The input prompts 700 may be provided in English or any other natural language format. For example, as shown in FIG. 7, the input prompts 700 (e.g., 702a, 702b 704a, 704b) may be provided foreign language characters. The system prompt (702a, 704a) may include, for example, a greeting (e.g., “hello”) or instructions for operating the model (e.g., “please enter a question”) . In some aspects, the system prompt (702a, 704a) may also indicate a format for the input prompt (e.g., according to the JavaScript Object Notation (JSON) file format). The system prompt (702a, 704a) may be fixed in length and may be the same for each input prompt.

The user prompt (702b, 704b) may include a question or task specified by a user, for instance. The user prompt may be variable in length. For instance, user prompt 702b is greater in length than user prompt 704b.

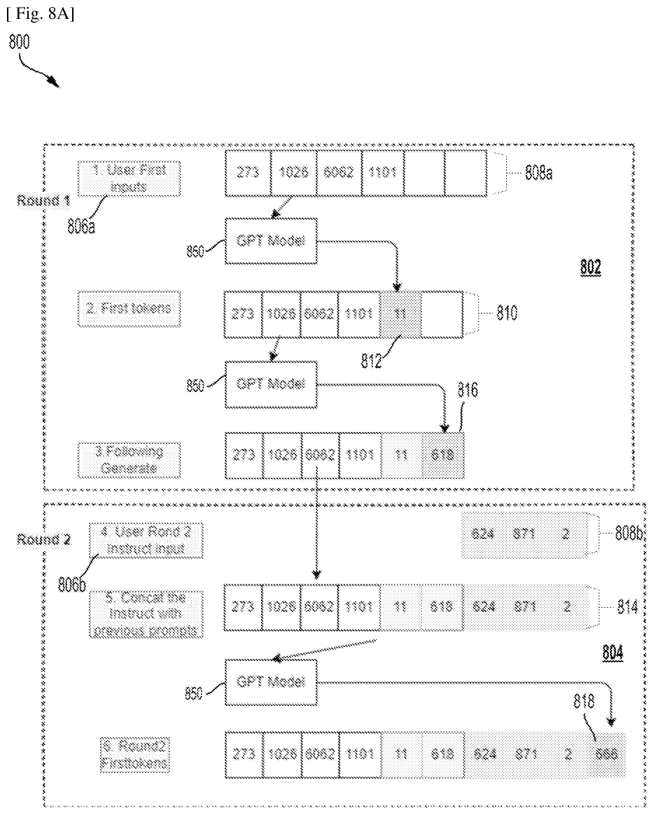

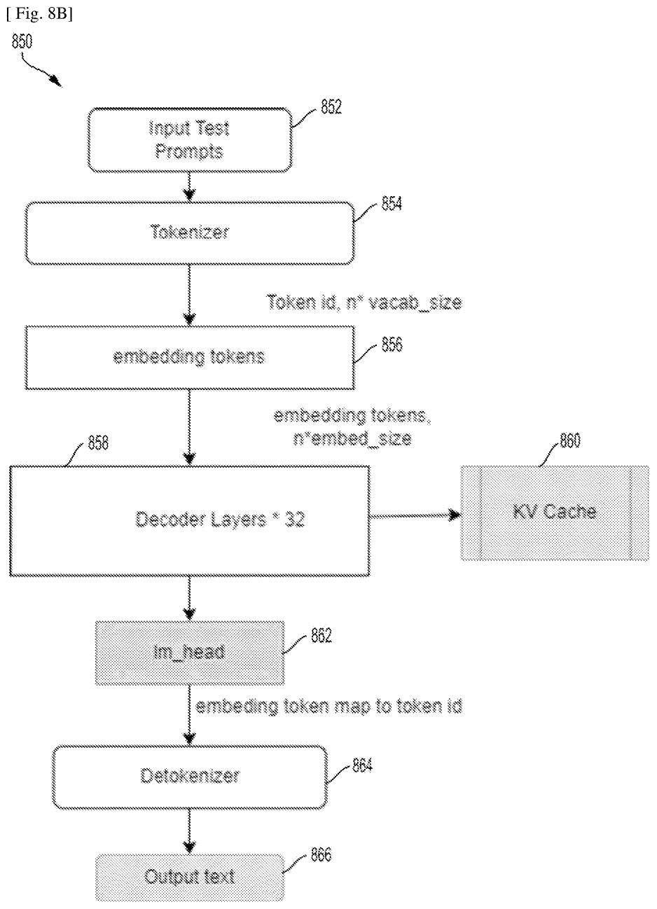

FIG. 8A is a block diagram illustrating example use cases 800 for a KV model for token generation, in accordance with various aspects of the present disclosure. Referring to FIG. 8A, the example use cases 800 may include a single conversion use case 802 or a multi-round chat use case 804. The single conversion use case 802 may include uses in which only one user input is provided and processed for generating an inference. On the other hand, the multi-round chat use case 804 may include uses in which additional user inputs may be provided and processed to determine the inference.

In the single conversion use case 802, a first user input 806a may be received. The first user input 806a may include a user prompt (e.g., 702b, 704b) such as a question or task specified by a user, for instance. In some aspects, the first user input 806a may also include a system prompt (e.g., 702a, 704a). The first user input 806a may be tokenized using the KV model 600, for example, to generate a first set of input tokens 808a. Each token of the first set of input tokens 808a may be represented as an integer number. The first set of input tokens 808a may be provided to a GPT model 850 to generate a first token 812. The first token 812 may be concatenated to the first set of input tokens 808a to produce a next set of tokens 810. The next set of tokens 810 may, in turn, be provided as an input to the GPT model 850. The GPT model 850 processes the next set of tokens 810 and may generate an output token 816.

In the multi-round chat use case 804, a second user input 806b may be received. The second user input 806b may be tokenized, for instance, using the KV model 600 to generate a second set of input tokens 808b. The output token 816 may be concatenated to the next set of tokens 810 and the second set of input tokens 808b to produce a following token 814. The following token 814 may be provided to the GPT model 850. The GPT model 850 processes the following token 814 to determine a second output token 818. Further rounds in the multi-round chat use case 804 may be conducted in a similar fashion upon receipt of additional user inputs (e.g., 806a, 806b).

FIG. 8B is a block diagram illustrating an architecture of the GPT model 850 of FIG. 8A, in accordance with various aspects of the present disclosure. Referring to FIG. 8B, the GPT model 850 may include a tokenizer 854, decoder layers 858, a language modelling (LM) head 862, and a detokenizer 864. The tokenizer 854 may receive an input prompt 852 and generate a set of embedding tokens 856. The set of embedding tokens 856 may be similar to sets of input tokens 808a and 808b of FIG. 8A.

The embedding tokens 856 may be provided to the decoder layer 858. The decoder layers 858 may process the embedding tokens 856 to determine the internal state (KV cache 860. The internal state may also be provided to the LM head 862. LM heads may include (but are not limited to) alinear layer having input dimension of hidden state and output dimension of vocabulary size. LM heads may map hidden state outputs (e.g., the internal state (KV cache 860) to a specific token in a vocabulary. The LM head 862 may map the embedding tokens 856 to a token corresponding to a token identifier. The token identifier may be provided to the detokenizer 864. The detokenizer 864 may perform a reciprocal function to that performed by the tokenizer 854 to convert the tokens corresponding to the token identifiers output by the LM head 862 to characters of output text 866.

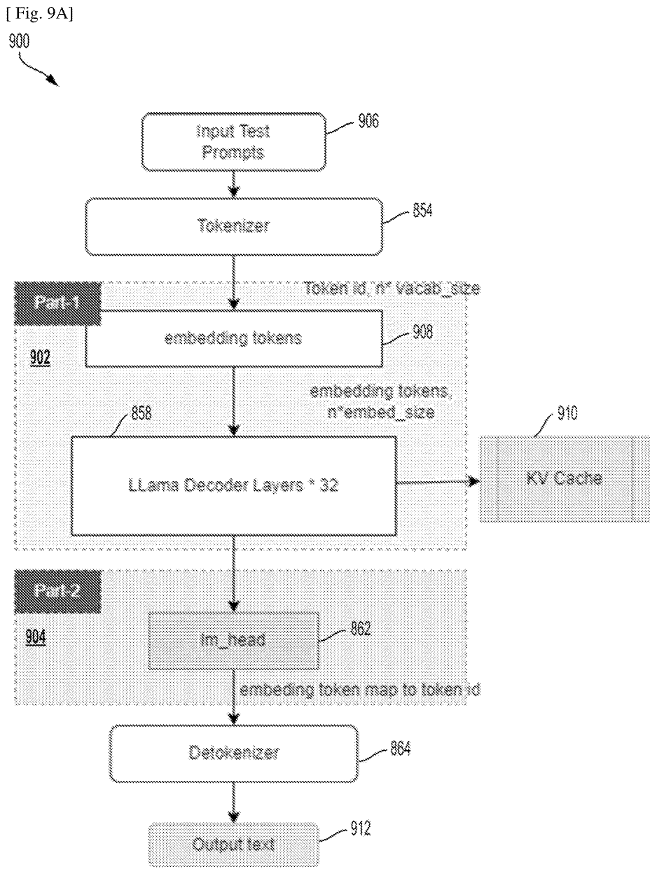

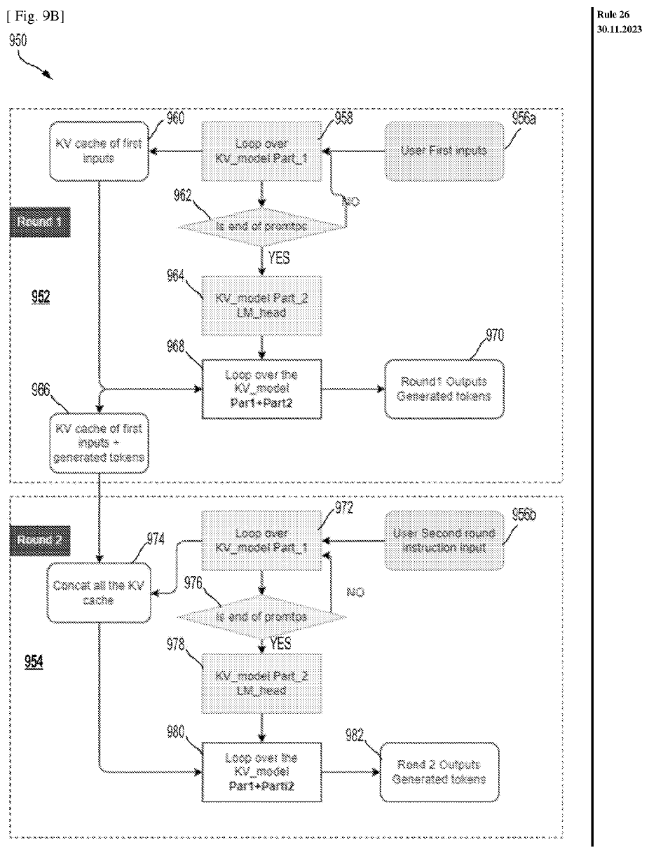

FIG. 9A is a block diagram illustrating an example architecture 900 for accelerating prompt inferencing, in accordance with various aspects of the present disclosure. Referring to FIG. 9A, the architecture 900 includes components similar to those included in the GPT model 850. However, the components may be split into two separate portions: part 1 902 and part 2 904. When the KV model 600 can be used to determine inferences (e.g., the internal state (KV cache) ) for the input prompts, the internal state may be determined without using the LM head 862. By using the KV model 600 for inferencing the input prompts, the LM head 862 may not be used prior to the last token of the prompts, thereby reducing model inference time and model latency.

Part 1 902 may include the decoder layers 858. Part 1 902 may process each token of user input 906 in an iterative fashion to generate the internal state (KV cache 910) for each of the embedding tokens 908. When the end of the input prompt has been reached, the tokens and KV cache may be provided to part 2 904 to determine a model inference. For instance, the embedding tokens 908 and the KV cache 910 may be provided to the LM head 862. The LM head 862 may process the embedding tokens 908 and the KV cache 910 to generate output tokens and corresponding token identifiers. The output tokens and token identifiers may be supplied to the detokenizer 864. The detokenizer 864 in turn may generate output text 912.

FIG. 9B is a flow diagram illustrating a process pipeline 950 for accelerating prompt inferencing, in accordance with various aspects of the present disclosure. The pipeline 950 may be split into two rounds, round 1 952 and round 2 954. Round 1 952 may correspond to the single conversion use case 802 and round 2 954 may correspond to the multi-round chat use case 804 of FIG. 8A.

In round 1 952, at block 956 a, a first user input may be received. At block 958, the pipeline 950 may loop over the KV model part 1 to determine a KV cache 960 for each of the tokens of the first user input. At block 962, the pipeline may determine whether the end of the input prompts has been reached. If the end of the prompts has not been reached, the pipeline returns to block 958 to determine the KV cache for remaining tokens of the first user input. After the KV cache for all of the tokens of the first user input have been determined, at block 964, the pipeline 950 may use the LM head (e.g., 860) to loop over part 1 and part 2 (block 968). That is, the pipeline 950 may use the LM head to process input tokens and the corresponding KV cache to generate round 1 output tokens at block 970. At block 966, the KV cache and generated tokens may be collected. In some aspects the KV cache and generated tokens may be stored, for instance in a buffer (e.g., 516).

In round 2 954, at block 956b, a second user input may be received. At block 972, the pipeline 950 may loop over the KV model part 1 to determine the KV cache 960 for each of the tokens of the first user input. At block 974, the KV cache of the first user inputs and generated tokens may be concatenated with the KV cache determined for the second user input. At block 976, the pipeline may determine whether the end of the input prompts of the second user input has been reached. If the end of the prompts has not been reached, the pipeline returns to block 972 to determine the KV cache for remaining tokens of the second user input. After the KV cache for all of the tokens of the second user input have been determined, at block 978, the pipeline 950 may use the LM head (e.g., 860) to loop over part 1 and part 2 (at block 980). The pipeline 950 may use the LM head to process input tokens and the corresponding KV cache to generate the round 2 output tokens at block 982. In some aspects, the KV cache for round 1 and round 2 and the generated tokens may be collected for use in additional subsequent rounds.

Accordingly, by using the KV model to loop over the user input prompts, aspects of the present disclosure may beneficially accelerate model inference and reduce latency.

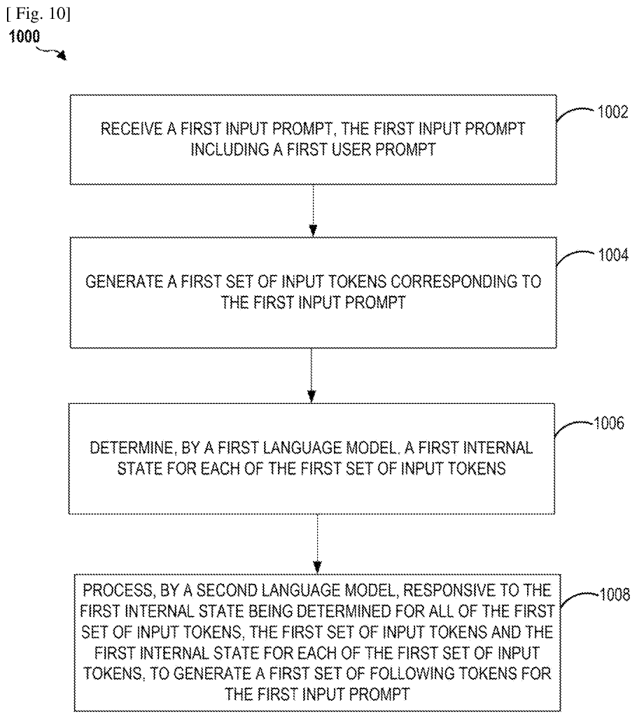

FIG. 10 is a flow diagram illustrating a processor-implemented method 1000 for accelerating prompt inferencing in large language models, in accordance with various aspects of the present disclosure. The processor-implemented method 1000 may be performed by one or more processors such as the CPU (e.g., 102, 422), GPU (e.g., 104, 426), and/or other processing unit (e.g., DSP 424, NPU 428), for example.

At block 1002, the one or more processors receive a first input prompt, the first input prompt including a first user prompt. For example, as described with reference to FIG. 8A, a first user input 806a may be received. The first user input 806a may include a user prompt (e.g., 702b, 704b) such as a question or task specified by a user, for instance. In some aspects, the first user input 806a may also include a system prompt (e.g., 702a, 704a). The first user input 806a may also be tokenized using the KV model 600, for example, to generate a first set of input tokens 808a. Each token of the first set of input tokens 808a may be represented as an integer number.

At block 1004, the one or more processors determine, by a first language model, a first internal state for each of the first set of input tokens. As described, for instance, with reference to FIG. 8A, the first set of input tokens 808a may be provided to a GPT model 850 to generate a first token 812.

At block 1006, the one or more processors process, by a second language model, responsive to determining the first internal state for all of the first set of input tokens, the first set of input tokens and the first internal state for each of the first set of input tokens, to generate a first set of following tokens for the first input prompt. For example, as described with reference to FIG. 8A, the first token 812 may be concatenated to the first set of input tokens 808a to produce a next set of tokens 810. The next set of tokens 810 may, in turn, be provided as an input to the GPT model 850. The GPT model 850 processes the next set of tokens 810 and may generate an output token 816.

Implementation examples are included in the following numbered clauses.
1. An apparatus, comprising:
at least one memory; and
at least one processor coupled to the at least one memory, the at least one processor configured to:
receive a first input prompt, the first input prompt including a first user prompt;
generate a first set of input tokens corresponding to the first input prompt;
determine, by a first language model, a first internal state for each of the first set of input tokens; and
process, by a second language model, responsive to the first internal state being determined for all of the first set of input tokens, the first set of input tokens and the first internal state for each of the first set of input tokens, to generate a first set of following tokens for the first input prompt.
2. The apparatus of clause 1, in which the at least one processor is further configured to determine, by the second language model, a first inference based on the first set of following tokens.
3. The apparatus of clause 1 or 2, in which the at least one processor is further configured to:
receive a second input prompt, the second input prompt including a second user prompt;
generate a second set of input tokens corresponding to the second input prompt;
determine, by the first language model, a second internal state for each of the second set of input tokens; and
process, by the second language model, responsive to determining the second internal state for all input tokens, the second set of input tokens, the first set of following tokens, the first internal state for each of the first set of input tokens, and the second internal state for each of the second set of input tokens, to generate a second set of following tokens for the second input prompt.
4. The apparatus of any of clauses 1-3, in which the at least one processor is further configured to determine, by the second language model, a second inference based on the second set of following tokens.
5. The apparatus of any of clauses 1-4, in which the second language model includes a language modelling (LM) head.
6. The apparatus of any of clauses 1-5, in which the first language model generates the first internal state without using the LM head.
7. A processor-implemented method performed by at least one processor, the processor implemented method comprising:
receiving a first input prompt, the first input prompt including a first user prompt;
generating a first set of input tokens corresponding to the first input prompt;
determining, by a first language model, a first internal state for each of the first set of input tokens; and
processing, by a second language model, responsive to determining the first internal state for all of the first set of input tokens, the first set of input tokens and the first internal state for each of the first set of input tokens, to generate a first set of following tokens for the first input prompt.
8. The processor-implemented method of clause 7, further comprising determining, by the second language model, a first inference based on the first set of following tokens.
9. The processor-implemented method of clause 7 or 8, further comprising:
receiving a second input prompt, the second input prompt including a second user prompt;
generating a second set of input tokens corresponding to the second input prompt;
determining, by the first language model, a second internal state for each token of the second set of input tokens; and
processing, by the second language model, responsive to determining the second internal state for all input tokens, the second set of input tokens, the first set of following tokens, the first internal state for each of the first set of input tokens, and the second internal state for each of the second set of input tokens, to generate a second set of following tokens for the second input prompt.
10. The processor-implemented method of any of clauses 7-9, further comprising determining, by the second language model, a second inference based on the second set of following tokens.
11. The processor-implemented method of any of clauses 7-10, in which the second language model includes a language modelling (LM) head.
12. The processor-implemented method of any of clauses 7-11, in which the first language model generates the first internal state without using the LM head.
13. A non-transitory computer-readable medium having program code recorded thereon, the program code executed by a processor and comprising:
program code to receive a first input prompt, the first input prompt including a first user prompt;
program code to generate a first set of input tokens corresponding to the first input prompt;
program code to determine, by a first language model, a first internal state for each of the first set of input tokens; and
program code to process, by a second language model, responsive to determining the first internal state for all of the first set of input tokens, the first set of input tokens and the first internal state for each of the first set of input tokens, to generate a first set of following tokens for the first input prompt.
14. The non-transitory computer-readable medium of clause 13, in which the program code comprises program code to determine, by the second language model, a first inference based on the first set of following tokens.
15. The non-transitory computer-readable medium of clause 13 or 14, in which the program code comprises:
program code to receive a second input prompt, the second input prompt including a second user prompt;
program code to generate a second set of input tokens corresponding to the second input prompt;
program code to determine, by the first language model, a second internal state for each token of the second set of input tokens; and
program code to process, by the second language model, responsive to determining the second internal state for all input tokens, the second set of input tokens, the first set of following tokens, the first internal state for each of the first set of input tokens, and the second internal state for each of the second set of input tokens, to generate a second set of following tokens for the second input prompt.
16. The non-transitory computer-readable medium of any of clauses 13-15, in which the program code comprises program code to determine, by the second language model, a second inference based on the second set of following tokens.
17. The non-transitory computer-readable medium of any of clauses 13-16, in which the second language model includes a language modelling (LM) head.
18. The non-transitory computer-readable medium of any of clauses 13-17, in which the first language model generates the first internal state without using the LM head.
19. An apparatus comprising:
means for receiving a first input prompt, the first input prompt including a first user prompt;
means for generating a first set of input tokens corresponding to the first input prompt;
means for determining, by a first language model, a first internal state for each of the first set of input tokens; and
means for processing, by a second language model, responsive to determining the first internal state for all of the first set of input tokens, the first set of input tokens and the first internal state for each of the first set of input tokens, to generate a first set of following tokens for the first input prompt.
20. The apparatus of clause 19, further comprising means for determining, by the second language model, a first inference based on the first set of following tokens.
21. The apparatus of clause 19 or 20, further comprising:
means for receiving a second input prompt, the second input prompt including a second user prompt;
means for generating a second set of input tokens corresponding to the second input prompt;
means for determining, by the first language model, a second internal state for each token of the second set of input tokens; and
means for processing, by the second language model, responsive to determining the second internal state for all input tokens, the second set of input tokens, the first set of following tokens, the first internal state for each of the first set of input tokens, and the second internal state for each of the second set of input tokens, to generate a second set of following tokens for the second input prompt.
22. The apparatus of any of clauses 19-21, further comprising means for determining, by the second language model, a second inference based on the second set of following tokens.
23. The apparatus of any of clauses 19-22, in which the second language model includes a language modelling (LM) head.
24. The apparatus of any of clauses 19-23, in which the first language model generates the first internal state without using the LM head.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/ or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc. ), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus, comprising:
at least one memory; and
at least one processor coupled to the at least one memory, the at least one processor configured to:
receive a first input prompt, the first input prompt including a first user prompt;
generate a first set of input tokens corresponding to the first input prompt;
determine, by a first language model, a first internal state for each of the first set of input tokens; and
process, by a second language model, responsive to the first internal state being determined for all of the first set of input tokens, the first set of input tokens and the first internal state for each of the first set of input tokens, to generate a first set of following tokens for the first input prompt.

2. The apparatus of claim 1, in which the at least one processor is further configured to determine, by the second language model, a first inference based on the first set of following tokens.

3. The apparatus of claim 1, in which the at least one processor is further configured to:
receive a second input prompt, the second input prompt including a second user prompt;
generate a second set of input tokens corresponding to the second input prompt;
determine, by the first language model, a second internal state for each of the second set of input tokens; and
process, by the second language model, responsive to determining the second internal state for all input tokens, the second set of input tokens, the first set of following tokens, the first internal state for each of the first set of input tokens, and the second internal state for each of the second set of input tokens, to generate a second set of following tokens for the second input prompt.

4. The apparatus of claim 3, in which the at least one processor is further configured to determine, by the second language model, a second inference based on the second set of following tokens.

5. The apparatus of claim 1, in which the second language model includes a language modelling (LM) head.

6. The apparatus of claim 5, in which the first language model generates the first internal state without using the LM head.

7. A processor-implemented method performed by at least one processor, the processor implemented method comprising:
receiving a first input prompt, the first input prompt including a first user prompt;
generating a first set of input tokens corresponding to the first input prompt;
determining, by a first language model, a first internal state for each of the first set of input tokens; and
processing, by a second language model, responsive to determining the first internal state for all of the first set of input tokens, the first set of input tokens and the first internal state for each of the first set of input tokens, to generate a first set of following tokens for the first input prompt.

8. The processor-implemented method of claim 7, further comprising determining, by the second language model, a first inference based on the first set of following tokens.

9. The processor-implemented method of claim 7, further comprising:
receiving a second input prompt, the second input prompt including a second user prompt;
generating a second set of input tokens corresponding to the second input prompt;
determining, by the first language model, a second internal state for each token of the second set of input tokens; and
processing, by the second language model, responsive to determining the second internal state for all input tokens, the second set of input tokens, the first set of following tokens, the first internal state for each of the first set of input tokens, and the second internal state for each of the second set of input tokens, to generate a second set of following tokens for the second input prompt.

10. The processor-implemented method of claim 9, further comprising determining, by the second language model, a second inference based on the second set of following tokens.

11. The processor-implemented method of claim 7, in which the second language model includes a language modelling (LM) head.

12. The processor-implemented method of claim 11, in which the first language model generates the first internal state without using the LM head.

13-18. (canceled)

19. An apparatus comprising:
means for receiving a first input prompt, the first input prompt including a first user prompt;
means for generating a first set of input tokens corresponding to the first input prompt;
means for determining, by a first language model, a first internal state for each of the first set of input tokens; and
means for processing, by a second language model, responsive to determining the first internal state for all of the first set of input tokens, the first set of input tokens and the first internal state for each of the first set of input tokens, to generate a first set of following tokens for the first input prompt.

20. The apparatus of claim 19, further comprising means for determining, by the second language model, a first inference based on the first set of following tokens.

21. The apparatus of claim 19, further comprising:
means for receiving a second input prompt, the second input prompt including a second user prompt;
means for generating a second set of input tokens corresponding to the second input prompt;
means for determining, by the first language model, a second internal state for each token of the second set of input tokens; and
means for processing, by the second language model, responsive to determining the second internal state for all input tokens, the second set of input tokens, the first set of following tokens, the first internal state for each of the first set of input tokens, and the second internal state for each of the second set of input tokens, to generate a second set of following tokens for the second input prompt.

22. The apparatus of claim 21, further comprising means for determining, by the second language model, a second inference based on the second set of following tokens.

23. The apparatus of claim 19, in which the second language model includes a language modelling (LM) head.

24. The apparatus of claim 23, in which the first language model generates the first internal state without using the LM head.
